(19) United States
(12) Patent Application Publication
(10) Pub. No.: US 2009/0267310 A1
(43) Pub. Date: Oct. 29, 2009

(54) WHEELCHAIR LIFT ASSIST DEVICE

(76) Inventor: David L. PARKHURST, SR., Sweetwater, NJ (US)

Correspondence Address: Diane Dunn McKay, Esq.;PORZIO, BROMBERG & NEWMAN, P.C., Suite 201, 29 Thanet Road, Princeton, NJ, 08540, US

(21) Appl. No.: 12/428,553

(22) Filed: Apr. 23, 2009

Related U.S. Application Data
(60) Provisional application No. 61/125,366, filed on Apr. 24, 2008.

(51) Int. Cl. A61G 5/06; A61G 5/02

(52) U.S. Cl. 280/5.3

(57) ABSTRACT

This invention relates to a wheelchair lift extension device comprising an extension, a bar, which connects to the bottom frame of a wheelchair and when pressure is applied to the opposite end of the bar, it assists in raising the wheelchair over thresholds and curbs. The extension bar includes a first horizontal section, a vertical section having a first end attached to the first horizontal section and a second end extending downwardly from the first horizontal section. A second horizontal section is attached to the second end of the vertical section.

### CROSS REFERENCE TO RELATED APPLICATION

This application claims the benefit of U.S. Provisional Patent Application No. 61/125,366, filed Apr. 24, 2008, the entirety of which is hereby incorporated by reference into this application.

### BACKGROUND OF THE INVENTION

1. Field of the Invention

The invention relates to a wheelchair lift assist device in which an extension bar connects to the bottom frame of a wheelchair and when pressure is applied to an end of the extension bar it assists in raising the wheelchair over thresholds and curbs.

2. Description of Related Art

Manual wheelchairs have significant difficulty climbing curbs. If a curb cutout is not available or is located at a distance from the wheelchair, a person pushing the wheelchair has difficulty tilting the wheelchair by raising the front of the wheelchair up a curb or step or tracks of a sliding glass door.

It is desirable to provide wheelchair lift assist device for use with a wheelchair for assisting in raising the wheelchair over the threshold and curbs.

### SUMMARY OF THE INVENTION

This invention relates to a wheelchair lift extension device comprising an extension, a bar, which connects to the bottom frame of a wheelchair and when pressure is applied to the opposite end of the bar, it assists in raising the wheelchair over thresholds and curbs. The extension bar includes a first horizontal section, a vertical section having a first end attached to the first horizontal section and a second end extending downwardly from the first horizontal section. A second horizontal section is attached to the second end of the vertical section. A distal end of the second horizontal section extends away from the first horizontal section. The invention enables the person pushing the wheelchair to, including but not limited to, lift the front of the chair up a curb, step, as well over uneven sidewalk, thresholds, and the tracks of sliding glass doors. It provides a safer, smoother ride for the person riding in the chair and makes for easier maneuvering of the chair for the person pushing the chair.

The invention will be more fully described by reference to the following drawings.

### BRIEF DESCRIPTION OF THE DRAWINGS

FIG. 1 is a schematic diagram of the wheelchair lift assist device for use with a wheelchair in accordance with the teachings of the present invention.

FIG. 2 is a schematic diagram of an embodiment of the wheelchair lift assist device upon attachment to a wheelchair.

FIG. 3 is a schematic diagram of an embodiment of the wheelchair lift assist device shown in FIG. 2.

FIG. 4 is a top plan view of the wheelchair lift device.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

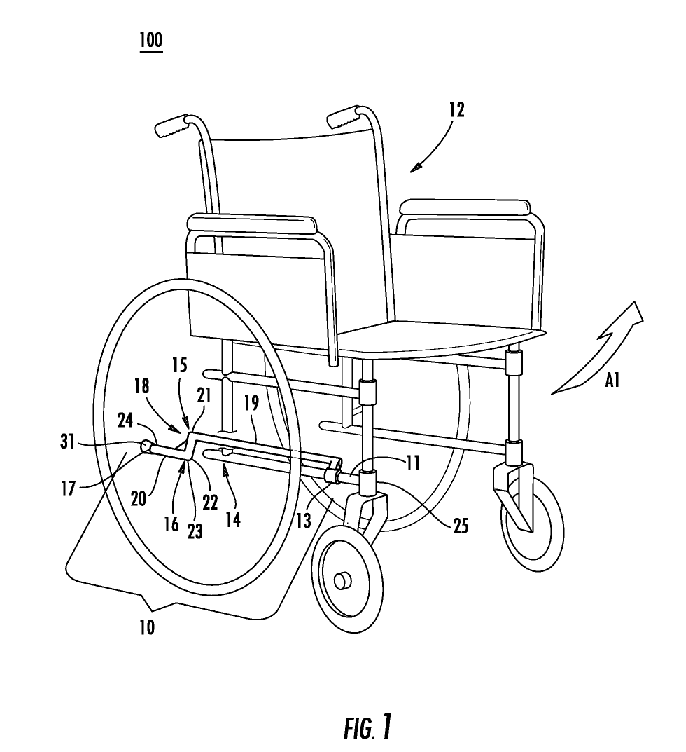

FIG. 1 is a schematic diagram of wheelchair lift assist device 100 in accordance with the teachings of the present invention. Wheelchair lift assist device 100 comprises extension bar 10 which attaches to bottom frame 11 of wheelchair 12, either on the left hand side or on the right hand side. Extension bar 10, for example, can be attached via u-bolts 13. Extension bar 10 extends out from bottom frame 11 of wheelchair 12 horizontally and parallel to bottom frame 11 of wheelchair 12 until substantially near end 14 of bottom frame 11 or along a portion of wheelchair 12, and then extension bar 10 is bent vertically 15 and then bent again horizontally 16 such that extension bar 10 extends out further from the bottom frame of wheelchair 12. In one embodiment, extension bar 10 is bent vertically at 90 degrees. In one embodiment, extension bar 10 is bent horizontally at 90 degrees. Extension bar 10 comprises first horizontal section 19 parallel to bottom frame 11 of wheelchair 12, vertical section 18 and second horizontal section 20. Vertical section 18 includes first end 21 attached to first horizontal section 19 and second end 22 extending downwardly from first horizontal section 19. Second horizontal section 20 has first end 23 attached to second end 22 vertical section 18 and second end 24 extending away from bottom frame 11. When a pusher of wheelchair 12 steps on end 17 of extension bar 10 to downwardly displace second horizontal section 20, it provides leverage that makes front 25 of wheelchair 12 go up in an upwardly direction, as shown by the arrow A₁. Extension bar 10 can be made of metal or plastic. For example, extension bar 10 can be formed of aluminum. Rubber tip 31 can also be added at second end 24 of second horizontal bar 20 for better traction when force is applied to extension bar 10 such that the foot of the person pushing wheelchair 12 will not slip off of extension bar 10 when tipping wheelchair 12 back.

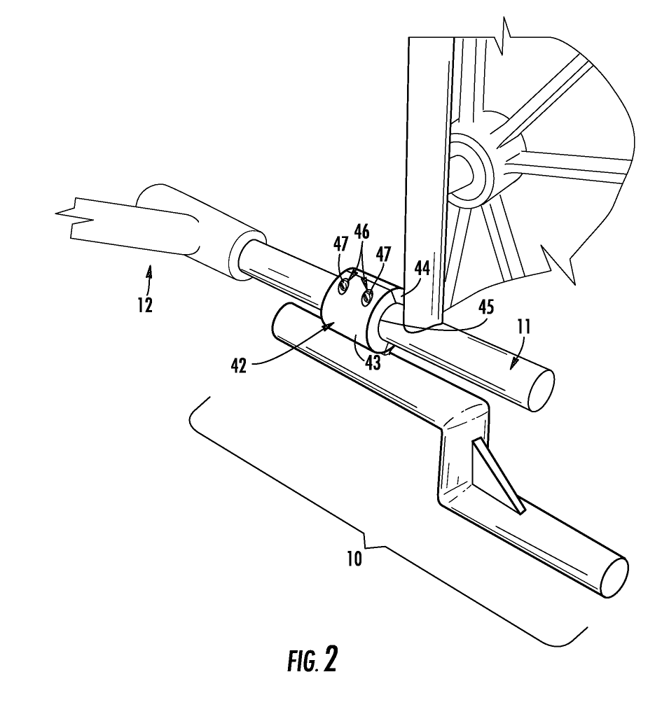

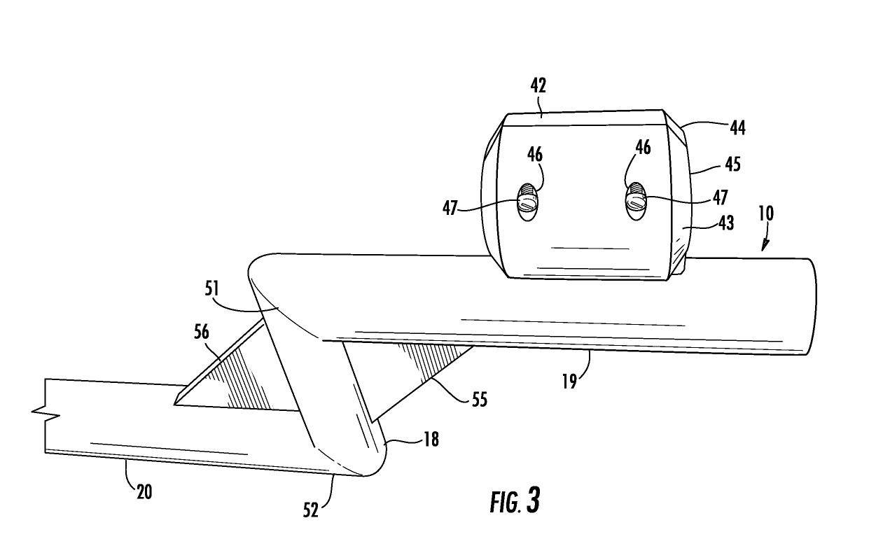

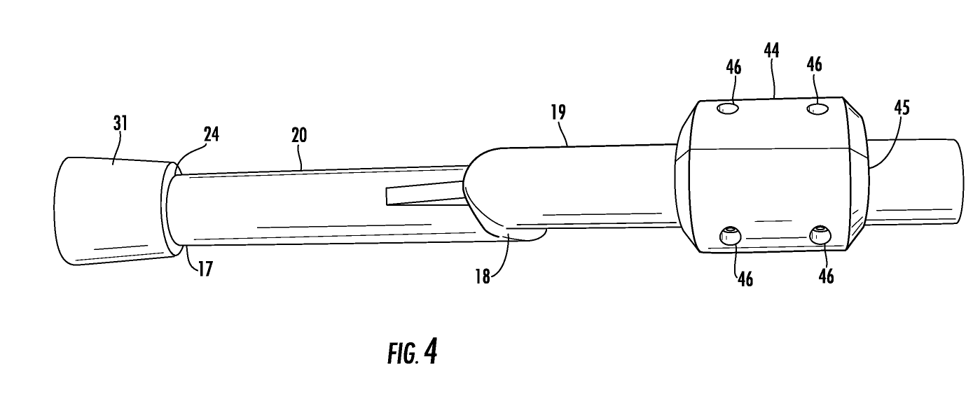

FIGS. 2-4 illustrate an alternative embodiment for attachment of extension bar 10 to wheelchair 12. Extension bar 10 can be attached to bottom frame 11 of wheelchair 12 by welding extension bar 10 to attachment bar 42, as shown in FIG. 2. Alternatively, extension bar 10 and attachment bar 42 can be of a monolithic construction. Attachment bar 42 is formed of first piece 43 and second piece 44, as shown in FIG. 3. When first piece 43 and second piece 44 are coupled to one another cavity 45 is formed between first piece 43 and second piece 44. First piece 43 of attachment bar 42 can be coupled to first horizontal section 19 wherein second piece 44 of attachment bar 42 is placed over bottom frame 11 of wheelchair 12 and is coupled to first piece 43 of attachment bar 42 for holding first horizontal section 19 of extension bar 10 in cavity 45 and mounting extension bar 10 to bottom frame 11. First piece 43 and second piece 44 include apertures 46 which have been drilled for receiving placement of screws 47 such that bottom frame 11 of wheelchair 12 is placed within cavity 45 of attachment bar 42, when first piece 43 and second piece 44 of attachment bar 42 are placed together over bottom frame 11. Screws 47 can be added to apertures 46 and then tightened, such as with an allen wrench. FIG. 4 shows two screws 47 on one side of attachment bar 42 and two screws 47 on the opposite side of attachment bar 42. Screws 47 serve to tighten and attach attachment bar 42 to bottom frame 11.

Extension bar 10 can also be modified, as shown in FIG. 2, such that first horizontal section 19 of extension bar 10 is welded to vertical section 18 of extension bar 10 to form first joint 51 and vertical section 18 of extension bar 10 is welded to second horizontal section 20 of extension bar 10 to form second joint 52. In one embodiment first horizontal section 19, vertical section 18 and second horizontal section 20 are of monolithic construction.

Extension bar 10 can also be modified for further support by adding first enforcement piece 55 to first joint 51 where first horizontal section 19 of extension bar 10 joins with vertical section 18 of extension bar 10. Second enforcement piece 56 can be added to second joint 52 where vertical section 18 of extension bar 10 and second horizontal section 20 of extension bar 10 intersect. In one embodiment first horizontal section 19, vertical section 18, second horizontal section 20, first enforcement piece 55 and second enforcement piece 56 are of monolithic construction.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A lift assist device for use with a wheelchair comprising:
an extension bar, said extension bar including a first horizontal section, a vertical section having a first end attached to said first horizontal section and a second end extending downwardly from said first horizontal section, and a second horizontal section, said second horizontal section having a first end attached to said second end of said vertical section and a second end of said second horizontal section extending away from said first horizontal section; and
coupling means adapted for coupling said first horizontal section to a rear of a frame of a wheelchair,
wherein said second end of said second horizontal section of said extension bar is adapted during use to be displaced downwardly to cause a front of the frame of the wheelchair to raise upwardly.

2. The device of claim 1 wherein said extension bar is formed of metal or plastic.

3. The device of claim 1 wherein said extension bar is formed of aluminum.

4. The device of claim 1 further comprising:
a rubber tip, said rubber tip being received on said second end of said second horizontal section of said extension bar.

5. The device of claim 1 wherein said coupling means comprises:
one or more u-bolts.

6. The device of claim 1 wherein said coupling means comprises:
an attachment bar having a first piece and a second piece, said first piece and said second piece being removably coupled to one another, wherein when said first piece and said piece are coupled to one another a cavity is formed between said first piece and said second piece; said first piece of said attachment bar being adapted to be coupled to said first horizontal section when said second piece of said attachment bar is placed over said rear of the frame of said wheelchair, said second piece of said attachment bar is coupled to said first piece of said attachment bar for holding said first horizontal section of said extension bar in said cavity and mounting said extension bar to said frame.

7. The device of claim 6 wherein said first piece and said second piece of said attachment bar include a pair of aligned apertures and screws are received in said apertures for coupling said first piece to said second piece.

8. The device of claim 1 wherein said first horizontal section is attached to said first end of said vertical section with a first joint.

9. The device of claim 8 wherein said first joint welds said first horizontal section to said first end of said vertical section.

10. The device of claim 1 wherein said second horizontal section is attached to said second end of said vertical section with a second joint.

11. The device of claim 10 wherein said second joint welds said second horizontal section to said second end of said vertical section.

12. The device of claim 8 wherein a first enforcement plate is attached to said first joint between said first horizontal section and said first end of said vertical section.

13. The device of claim 10 wherein a second enforcement plate is attached to said second joint between said second horizontal section and said second end of said vertical section.

14. The device of claim 1 wherein said first horizontal section, said vertical section and said second horizontal section are of monolithic construction.

15. The device of claim 1 wherein said first horizontal section, said vertical section, said second horizontal section are of monolithic construction, said first enforcement plate and the second enforcement plate are of monolithic construction.

16. The device of claim 1 wherein said vertical section is positioned at 90 degrees from said first horizontal section.

17. The device of claim 1 wherein said vertical section is positioned at 90 degrees from said second horizontal section.

18. The device of claim 1 in combination with a wheelchair.
